(19) United States
(12) Patent Application Publication
(10) Pub. No.: US 2004/0015564 A1
(43) Pub. Date: Jan. 22, 2004

(54) Method of developing a web service and marketing products or services used in developing a web service

(76) Inventor: Scott Lane Williams, Santa Cruz, CA (US)

Correspondence Address: HEWLETT-PACKARD COMPANY, Intellectual Property Administration, P.O. Box 272400, Fort Collins, CO, 80527-2400, US

(21) Appl. No.: 10/093,691

(22) Filed: Mar. 7, 2002

(51) Int. Cl. G06F 15/16; G06F 9/00

(52) U.S. Cl. 709/219

(57) ABSTRACT

A method of developing a Web service includes: specifying a business protocol for communicating with said service, programming a Web service interface, constructing business objects and data, building a service workflow, mapping said interface to said business objects and workflow, packaging said service, deploying the service, advertising the service and monitoring the service. A method of marketing products or services used in developing a Web service includes presenting a Web service development model in conjunction with offering a product or service used in developing a Web Service.

### FIELD OF THE INVENTION

The present invention relates to the field of Web services. More specifically, the present invention relates to a method of developing a web service and a method of marketing products or services used in developing a web service.

### BACKGROUND OF THE INVENTION

“Web Services” is the term currently used within the software industry to signify functionality or “services” that are accessed over a network such as the Internet or World Wide Web (the “Web”). Such a service operates as follows. The client electronically submits a request and, perhaps, some input data that is transmitted across the network to the service. The service receives the transmission and performs some operation. The service may then return a response to the requesting client. The nature of the input data, the operation performed, etc., will depend on what the service is and does.

For example, a service may be a database. The client may submit a request that a search of the database be performed and a keyword to search for. The service then searches the database and returns the search result to the requesting client. Services may be simple, such as a service that returns a stock quote, or complex, such as a service that allows users to make car rental reservations or complete a loan application.

In used herein, and in the attached claims, a “Web service” is any electronic service that is provided over a network, for example, over the Internet or World Wide Web. Web services can also be provided on smaller networks, such as a local or wide area network.

At present, more and more services are being offered on the Web. There is a great rush to develop Web services and make them available to the vast clientele on the Internet. Developers are in constant need of better methods, tools, etc. for developing and implementing Web services. Reducing the time required to fully implement a Web service is a key priority.

The Universal Description, Discovery and Integration (UDDI) for Web services is an industry initiative to promote the interoperability and adoption of Web services. (See www.UDDI.org). The UDDI includes a global business registry of services available on the Internet. This registry has a standard Application Program Interface (API) and lists Web service providers, the services available and electronic access instructions for those services.

### SUMMARY OF THE INVENTION

The present invention includes a method of developing a Web service including specifying a business protocol for communicating with said service, programming a Web service interface, constructing business objects and data, building a service workflow, mapping said interface to said business objects and workflow, packaging said service, deploying the service, advertising the service and monitoring the service.

The present invention may also be embodied in a method of marketing products or services used in developing a Web service by presenting a Web service development model in conjunction with offering a product or service used in developing a Web Service.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention.

FIG. 1 is a flowchart illustrating a Web service development paradigm according to principles of the present invention.

FIG. 2 is diagram of a first step in a Web service development model according to principles of the present invention.

FIG. 3 is diagram of a second step in a Web service development model according to principles of the present invention.

FIG. 4 is diagram of a third step in a Web service development model according to principles of the present invention.

FIG. 5 is diagram of a fourth step in a Web service development model according to principles of the present invention.

FIG. 6 is diagram of a fifth step in a Web service development model according to principles of the present invention.

FIG. 7 is diagram of a sixth step in a Web service development model according to principles of the present invention.

FIG. 8 is diagram of a seventh step in a Web service development model according to principles of the present invention.

FIG. 9 is diagram of a eighth step in a Web service development model according to principles of the present invention.

FIG. 10 is diagram of a ninth step in a Web service development model according to principles of the present invention.

FIG. 11 is diagram of a preferred Web service development model according to principles of the present invention.

Throughout the drawings, identical reference numbers designate identical elements.

### DETAILED DESCRIPTION OF THE PREFERRED EMBODIMENTS

The present invention provides a Web service development paradigm or model that addresses the entire lifecycle of Web service development. This model greatly facilitates the development of Web services. It includes phases to define and describe, package and deploy, register, discover, monitor and mange a Web service. Using this model, corporate development teams can extend the functionality of existing software assets and quickly and easily deploy them as Web Services.

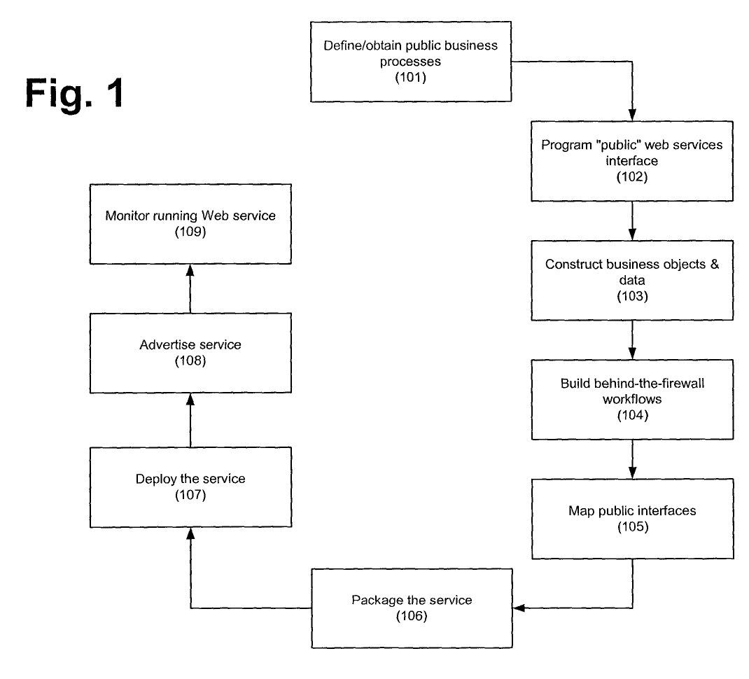

A preferred method of developing Web services according to principles of the present invention can be divided into nine steps or phases that can be performed in various orders to fully implement a Web service. FIG. 1 is a flowchart illustrating these nine phase of Web service development. These phases are illustrated in a preferred order. However, the phases can be performed in many other possible orders under the principles of the present invention.

As shown in FIG. 1, a Web service development model according to the present invention may include the following steps: (1) define or obtain public business processes (101), (2) program Web service interface for the public or authorized clients (102), (3) construct business objects and data (103), build the behind-the-firewall workflows (104), map the “public” interfaces (105), package the services (106), display the services (107), advertise the services (108) and monitoring the operation of the Web service (109). Each of these steps will be discussed in detail below.

To help explain the Web Service Development Lifecycle model of the present invention, we can use sales tax service as an example. In this example, a company, Provider, has enjoyed tremendous success a global widgets manufacturer. To support their global trade, the company created a unique JAVA application for calculating sales tax. Sales tax is an extremely complex problem for many businesses. For example, there are over 7,200 unique sales tax jurisdictions in the United States alone. Today, many companies are addressing the tax complexities by engaging in expensive outsourcing arrangements or by purchasing decentralized software applications that require constant updates.

The management team at Provider realizes that their sales tax application is a valuable asset, one that could be made even more valuable if it where transformed into a Web service. Web service technology offers Provider the ability to transform its proprietary tax application into a reusable, modular, self-contained service that could be used by new partners regardless of their underlying infrastructure. The third party simply had to know how to find and interact with the service. By following the steps of the Web Services Development Lifecycle, company Provider can revolutionize the way it does business and ensure that partners can quickly, easily locate and programmatically interact with the new tax service.

Phase 1: Define/Obtain Public Business Processes

In the beginning of the Web service development process, Provider must decide on the model customers will use to interact with the service. Provider can select a Remote Procedure Call (RPC) model in which the customer calls an explicit function of the Web service. Alternatively, Provider can choose a document exchange model in which the customer and the service would exchange a series of messages, e.g., extensible markup language (XML) messages, to complete the transaction. In our example, Provider may prefer a document exchange model because it enables Provider to decouple an incoming customer request to use the service from the actual fulfillment of that request for service.

To get started, Provider must select the communication protocol it wants to use with its service. The communication protocol will define the appropriate content for the documents or messages exchanged between the service and clients.

A tool (120), running on a computer or computer network, can be used by the Provider to select or define the communication protocol for its service. This tool (120) is preferably configured to read flow language files (i.e., communication protocol files) from disk and/or write such files to disk. The tool (120) also preferably has a graphical user interface (GUI). Thus, workflow can be represented graphically as a state diagram on the GUI and then represented on disk or in a registry as an XML document.

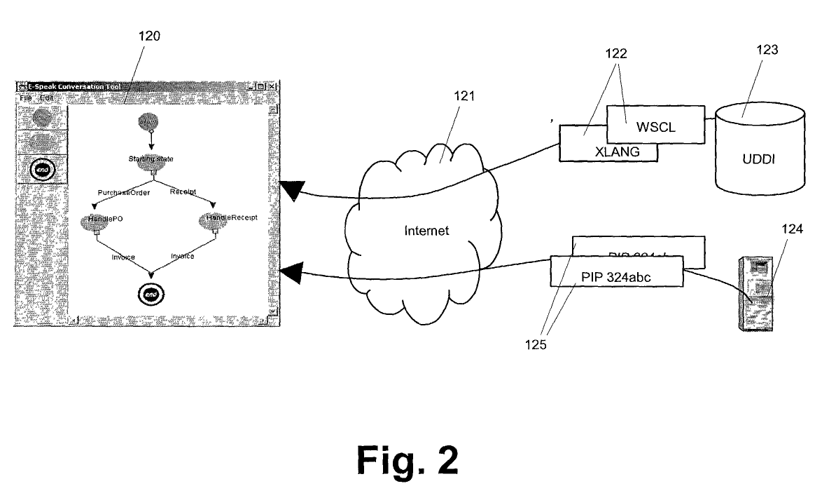

Using the tool (120), Provider can either select an existing communication protocol or can define a new custom communication protocol. As shown in FIG. 2, the tool (120) can download standard communication protocol files (e.g., 122, 125) from repositories, such as a UDDI registry (123), or from a proprietary server (e.g., 124). If a standard communication protocol (122, 125) is selected for download, it can be downloaded to the tool (120) via a computer network, such as the Internet (121).

Examples of existing communication protocols include Hewlett-Packard's Web Services Conversation Language (WSCL) (an XML vocabulary), RosettaNet's Partner Interface Processes (PIPs) (125), Microsoft's XLANG (an XML vocabulary), IBM's Web Services Flow Language, ebXML's XML vocabularies, and standard XML.

The tool (120) can also preferably publish the service's interface to the UDDI registry (123). This will be explained in more detail below in connection with another phase of the Web service development process.

Provider must also specify the order in which the documents are exchanged. For example, assume that Provider selected XML as the communication protocol and defined the following business process:

1. Customer sends a document LookUpTaxRateRequest to Provider

2. Provider sends the document LookUpTaxRateResponse back to the customer

3. Customer sends the document CalcTaxRateRequest

4. Provider sends the document CalcTaxRateResponse back to the customer

To actually create this public process, the Provider could use the graphical tool (120) to name each step in the process, edit its inputs and output XML schemas and specify which type of action is represented by the step. Each step will be one of four possible types:

1. One-way—The customer sends an XML document to the service and doesn't receive a corresponding XML response back from the Web service. This is analgous to when you send someone an email to let them know about something, but you don't expect them to reply to you.

2. Request-response—This is the most common type of action. In this type of action, the client sends an XML request to the service. The service processes the request and sends back an XML response to the client.

3. Solicit-response—This type of action is the mirror image of the Request-response type. In this type of action, the client is waiting for an XML message from the service. When the client receives an XML message from the Web service, the client processes the message and sends the Web service an XML response.

4. Notification—This type of action is the mirror image of a one-way action. In this type of action, the client of the Web service is waiting for an XML “notification” message to come from the service. When the service sends the notification to the client, the client processes that XML document but doesn't send a response back to the Web service.

Once the communication protocol for the service's clientele has been defined, Provider stores the metadata about the selected communication protocol in a configuration file. The configuration file is created by the tool (120) and then executed at runtime by the Web service runtime platform supporting the Web service.

Not all Web services will involve a rich, multi-step document exchange based model. Some developers may prefer to experiment with Web services by building simple RPC-based services. However, the true value and promise of Web services will be best achieved with the richer types of Web services. The document exchange model provides a more flexible foundation for these rich services since process for exchanging the document between businesses is logically separated from the actual processing of the document behind a firewall.

Phase II: Program ‘Public’ Web Service Interfaces

In this phase, the developer generates a file or files that describe the Web service. These files are preferably written in Web Services Description Language (WSDL), which is based on the XML standard. WSDL files may be prepared using command-line and graphical tools. A WSDL file describes, for example, the “request” and “response” messages that are exchanged with a Web service, the unique name (i.e., SOAPAction) used to invoke the Web service, the technical mechanism used to submit calls to the service (e.g., RPC, Simple Mail Transfer Protocol (SMTP), etc.), and the access points (usually Universal Resource Locators (URLs)) through which clients access the service.

A simple RPC-based Web service (where the Web service is just an XML “facade” for a callable method of an object or a script) can easily be generated by “Introspecting” the object or script that will provide the service. There are command-line and graphical tools that let you easily do this by choosing the method(s) you want to “expose” as a Web service. These tools will then generate the appropriate WSDL file(s) to describe the Web service.

However, as indicated above, many Web services are document-exchange based, rather than RPC-based. When a client interacts with this type of Web service, it isn't simply invoking a method provided by an object or a script. Instead, the client is sending an XML business document to the Web service and the Web service answers with another XML business document. In order to develop this type of Web service, as described above, a human being must use a graphical tool to generate a WSDL file. As indicated, the WSDL file describes, for example, the exchanged messages, the name of the Web service, which messages are input and which are output, etc.

In Phase I, Provider defined the communication protocol or “business metadata” for how to interact with the Web service, i.e., the language used to communicate with the Web service. In Phase II, Provider defines the “technical metadata” of the communication, or the mechanics for exchanging communications with the Web service. As indicated, Provider preferably does this by generating the appropriate Web Service Description Language (WSDL) file.

This WSDL file can be thought of as the technical fingerprint of the Web service. The WSDL file for a Web service describes how to invoke the service, the specific data being exchanged, the sequence of messaging, the bindings that may exist to underlying protocols, and the access points (usually URLs) through which customers access the service. The WSDL file is somewhat analogous to an IDL file in a CORBA development environment and is an abstract representation of the service, independent of the underlying language or component model.

For a service developer, generating the WSDL file does not have to be a tedious hand-coding effort. The developer could use a graphical tool, such as Service Composer™ by Hewlett-Packard to automatically generate the WSDL file from the existing Java-based application that provides the Web service. Such tools shield the developer from low-level complexity while enabling them to choose the underlying method or object they want to make available as a Web service.

In our example, the WSDL file can be generated based on the already existing sales tax calculation code. However, if the underlying code didn't already exist, Provider could use the WSDL description they created to actually generate the underlying business logic of the service. This development method is often referred to as a “top down” approach.

WSDL files are used in many ways to describe the public interfaces of Web services, including: (1) They are “published” into Web services registries—such as UDDI—in order to allow Web services to describe the technical specifications for communicating with them; (2) They are retrieved from Web service registries by software clients that want to interact with Web services; (3) They are retrieved from Web service registries by programmers who want to understand how to write client software that can interact with specific Web services; (4) They are used by tools to generate client-side “proxies” that enable programmers to easily communicate with Web services; (5) They are used by Web service compilers and runtimes platforms to generate server-side “skeletons” used in the implementation of Web services; etc.

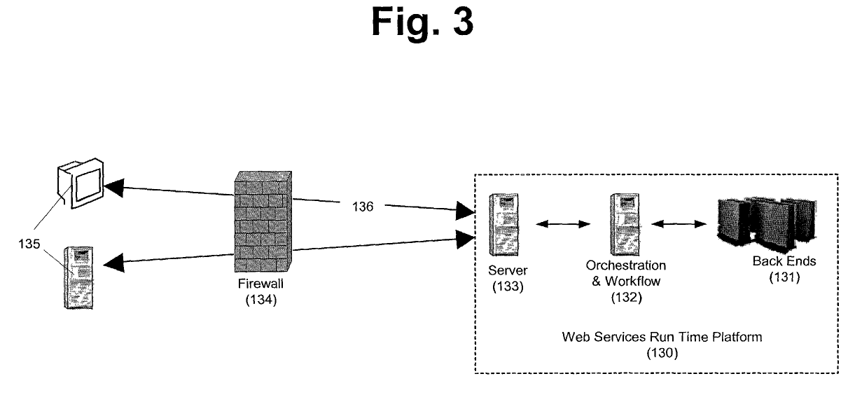

As shown in FIG. 3, the Web service is preferably provided on a Web Services Run Time Platform (130). The platform (130) may include a front server (133) running the software that provides the Web service, an orchestration and workflow server (132) that coordinates operation of the service with a host of back-end resources (131) that provide computing power for the service. In this way, the Web service is highly scalable.

A preferred example of a service platform (130) is the Web Services Platform by Hewlett-Packard. Preferably, the platform (130) provides a single architecture for creating and deploying Web services, as well as for publication and discovery of services in public and private registries. A preferred platform should also be robust and a modular Web services infrastructure that includes a JAVA 2 Enterprise Edition (J2EE) application server (133) and delivers interoperability with .NET. A preferred platform should also supports leading Web services standards such as Simple Object Access Protocol (SOAP), WSDL and UDDI.

As illustrated in FIG. 3, once the WSDL file is created and distributed for use by clients (135). Client devices (135) will be able to route documents or commands (136) across and network and, perhaps, through a firewall (134) to the Web services platform (130). The Web service is then invoked and may return an appropriate response to the clients (135).

Phase III: Construct Business Objects and Data

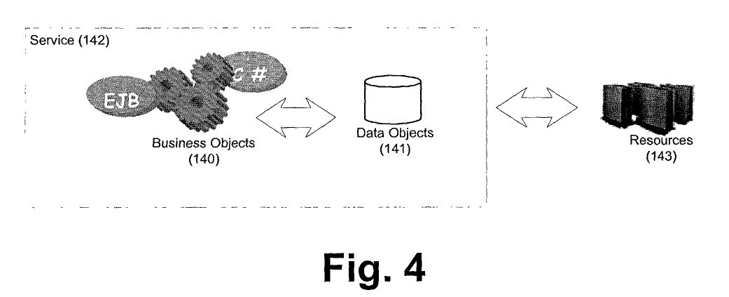

Referring to FIG. 4, the software that actually implements the “behind-the-firewall” business logic and data is constructed in phase three. In this step, the developer can use any of a variety of Integrated Development Environments (IDE's), text editors, database programming tools, etc. to generate the “business objects” (140) and “data objects” (141) that provide the Web service (142). Programmers can also use more “traditional” technologies, such as mainframe transactions, to implement business and data logic. In addition, the business logic constructed in this step can be implemented by aggregating existing Web services into a larger component. The service is created on and then supported by computing resources (143).

In our example of Provider's sales tax service, the business logic for the service has already been created and is in the form of a java application. However, the application could have been a .NET component, CORBA component, a database, C# or stored in a mainframe environment. Regardless of the form of the object and where it resides within the company, there are tools available on the market to extend the functionality of the software to make it a Web service.

The business logic (140) and associated objects (141) are the “brains” of the Web service (142) and address how an incoming document is processed. This step in the lifecycle is not unique to Web Services but addresses the standard development issue of programming business logic.

If the business logic did not already exist, Provider would now construct the underlying objects (140) through the text editors, database programming tools, etc. of their preferred IDE. Provider could also use more “traditional” technologies, such as mainframe transactions, to implement business and data logic. As indicated above, the business logic (140) constructed in this step could also be implemented by aggregating existing Web services into a larger component.

Phase IV: Build Behind-The-Firewall Workflows

In step four, the business (140) and data (141) components defined in step three can be combined into “behind-the-firewall” workflows in order to rapidly create new business functionality. Note that, unlike business-to-business workflows defined in step one of the WSDLC, the workflows defined in step four are not externally visible to Web service clients.

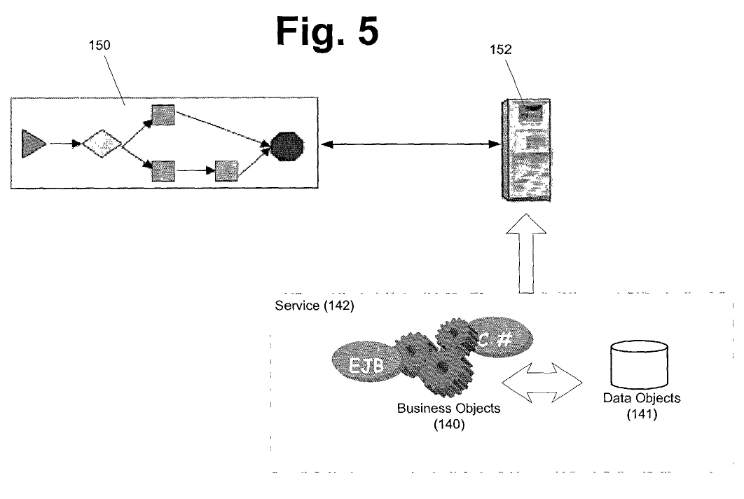

As shown in FIG. 5, a workflow tool (150) may be running on the system (152) used to create the desired workflows for the new Web service. The business objects (140) and data objects (141) created in the step three are also provided to the system (152) as inputs for the process of defining the service workflows.

A behind-the-firewall workflow is the “private” processing that the client of a Web service will not see. In fact, the steps of such a workflow are often a trade secret that provide a competitive advantage to the provider of a Web service. Consequently, the provider may not want to “expose” the service's workflow to its business partners. Developers in this step construct workflows using the graphical tools (e.g., 150) that frequently come bundled with their workflow engine (152). An example of a workflow tool (150) is the iGraphics tool by Hewlett-Packard Co. which is typically bundled with the Process Manager workflow engine. The iGraphics tool can be used to design and test the internal workflow.

At runtime, a workflow engine (152) can be one of the back-end components invoked by a Web services runtime platform (See FIG. 3). Each time a Web service receives an XML business document that is destined for the workflow, that document will be routed to the workflow engine (152) and the workflow engine (152) will then process it. Once the workflow engine (152) has executed all the steps required to process that document, it will hand control back to the Web services runtime platform, which will forward the workflow's response business document back to the client of the Web service.

Note that behind-the-firewall workflows are not a requirement for all Web services. Many valuable Web services can be implemented without the aid of a workflow engine.

Often, the behind-the-firewall code isn't just a single call to a JAVA application. In fact, in the example of a sales tax service, there are several steps involved, each supported by a different JAVA method. A workflow engine (152), such as the Process Manager by Hewlett-Packard Co., could be used to orchestrate these steps and the associated objects that perform these steps. So, just as earlier in the lifecycle Provider established the external workflow for the Web service, in this step, Provider specifies the internal workflow for processing the incoming documents.

Phase V: Map Public Interfaces

In step five, the public interfaces defined in steps one and two are mapped to the backend logic created in steps three and four. As an example, a WSDL interface might be mapped to a backend component for its concrete implementation. Simple SOAP-RPC based services generally create a 1-1 mapping between Web service operations (defined in a WSDL file) and a method call on an object or script.

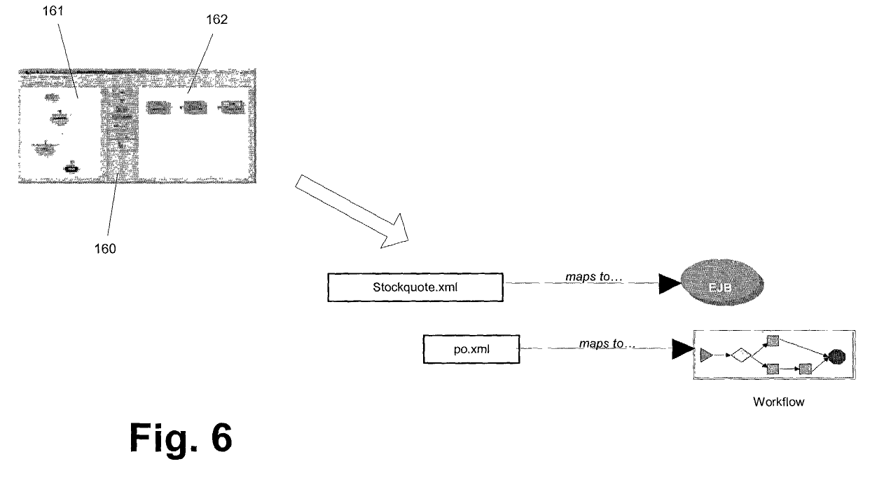

As shown in FIG. 6, the type of tool (160) (referred to here as a “Mapping Tool”) used in this step, might display a WSDL in the left-hand “public interface” panel (161) and will display icons representing the called methods/scripts in the right-hand “private implementation” panel (162). The user can then draw a directed arc from each “operation” in the left-hand panel (161) to the called method/script shown in the right-hand panel (162). In order to help the user “find callable “private implementation” components, the right-hand panel (161) could provide wizards that guide the user through his callable resources. These callable resources could be: JAVA objects, C# objects, C++ objects, VBScript modules, COM+ objects, EJB's, workflows, etc.

A more complex Web service might implement a multiple-step business-to-business process. A Web service might require that data from inbound XML documents be transformed into a different format. These richer, conversation-based (or “orchestrated”) Web Services are represented by a combination of WSDL documents and a flow language, such as WSCL, WSFL, or XLANG. The tool (160) could obtain the WSDL, WSFL, WSCL, etc. “public interface” descriptions from a number of possible locations, including from disk, from a UDDI registry or from a Web server. Then these public interfaces could be represented graphically in the left-hand “public interface” panel (161). As mentioned previously, the right-hand panel (162) could then be used to allow the user to choose which backend components and/or workflows could be invoked for each Web service call.

The output of the Mapping Tool (160) could be “mapping descriptors” used by the Web services runtime platform. The Web services runtime platform could use these files in order to understand where to route each received Web service request and how to transform/translate inbound and outbound data.

Phase VI: Package the Service

The packaged Web service is now deployed onto a Web services runtime platform where it will be hosted. Deployment might include specifying and customizing the transport(s) and access points (e.g., URLs) that will be used by clients to access the Web service. Other deployment-time customizations that might be done at this time include: selecting payment models, assigning security principles to roJes defined by the Web service, defining the environmental context under which the Web service will run, etc.

The interfaces are now defined and mapped to the underlying objects the callable business objects, data objects, and workflows (EJB's, database calls, etc.) have been coded, the Web services interfaces have been described, and the “public interfaces” for the Web service have been “mapped” to behind-the-firewall “implementations” of those interfaces. Provider is now ready to package the service.

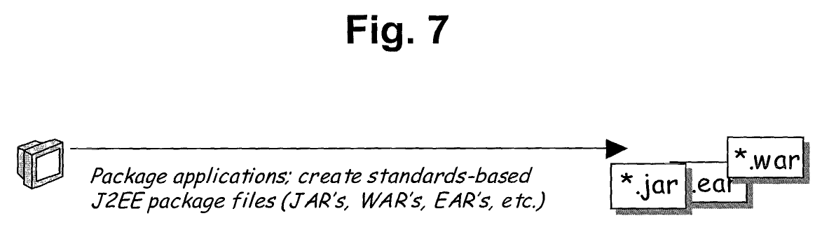

As shown in FIG. 7, the various components and descriptor files that make up the Web service can now be combined into an archive file (such as a jar or .war or .ear file) or whatever packaging format is appropriate for distribution and/or deployment on the runtime platform on which the Web service will be based. Once packaged, the Web service is easily deployed.

As in previous steps, tools exist to assist the developer in packaging the Web service. For example, Hewlett-Packard produces the Radpack tool which can be used to package a Web service at this phase of the development cycle.

Phase VII: Deploy Service to Infrastructure

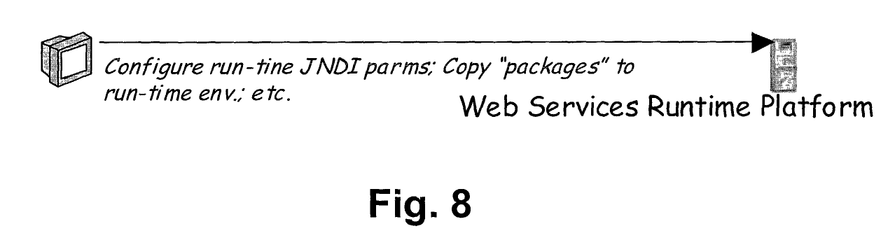

As shown in FIG. 8, the packaged Web service is now deployed onto a Web services runtime platform where it will be hosted. Deployment might include specifying and customizing the transport(s) and access points (e.g., URLs) that will be used by clients to access the Web service. Other deployment-time customizations that might be done at this time include: selecting payment models, assigning security principles to roles defined by the Web service, defining the environmental context under which the Web service will run, etc.

Phase VII: Advertise The Services

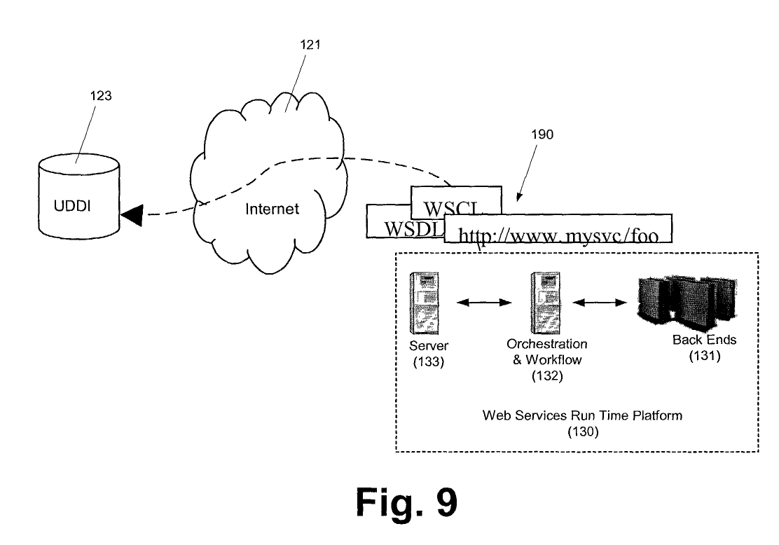

Once a Web service has been deployed, it can accept requests from clients. In step eight, the Web service is “advertised” so that clients can find and interact with the Web service. As shown in FIG. 9, this is generally done by adding an entry to a UDDI repository (123). The UDDI entry (190) for the Web service can include: business name, contact information, technical interface information, service access point (URL, etc.), quality of service information necessary to evaluate and use the service, etc.

Additionally, a person acting as a Web service deployer can advertise a Web Service “by hand” through the use of a graphical tool. For example, many Integrated Development Environments used to develop Web Services will provide mechanisms to easily deploy and advertise those services. Often, however, Web services will automatically advertise themselves (without requiring human intervention) by using facilities provided by the Web services runtime platform. Once a Web service has been advertised, clients can “find” the deployed Web service and interact with it.

The developer could create and post their UDDI “advertisement” by using a graphical tool such as Registry Composer by Hewlett-Packard Co. Through the use of wizards, Registry Composer enables developers to quickly and easily create entries for the appropriate UDDI fields such as Business Entities, Business Services, and TModels (the technical interface of the service). The Registry Composer tool also makes it easier for prospective customers to browse UDDI registries. With Registry Composer, they could search by business name, business category, unique identifier, or by TModel.

Once a prospective customer finds the sales tax service of our example, they can use its WSDL file to understand the operations the service supports and the parameters for each operation. Prospective customers and partners may also want to download the WSDL file to understand how to write software that can interact with the specific sales tax service.

Once the information is retrieved from UDDI, SOAP over HTTP can be used to invoke the sales tax service. Using the Unique Resource Name retrieved from the UDDI registry, the service can be invoked using an API that interacts with a SOAP server (133).

Phase IX: Monitor Running Web Services

Like traditional software models, the developer's job isn't complete once the software has been deployed. The ongoing monitoring and management of software is critical to its success. Web services provide no exception.

Tools exist and are under development to enhance a provider's ability to monitor and modify the operation of a deployed Web service. For example, OpenView and Web Service Registry from Hewlett-Packard Co. enable developers to make any necessary modifications or edit any information in the UDDI registry. Other tools available to manage and monitor Web services include: Web services runtime platform monitors, Simple Network Management Protocol (SNMP)-based tools, and other monitoring tools and techniques to monitor the health of the deployed Web service. Graphical tools will provide an end-to-end view of the service as it is used by clients and could monitor running conversations/flows, the current state of behind-the-firewall “private implementations” of the service, etc.

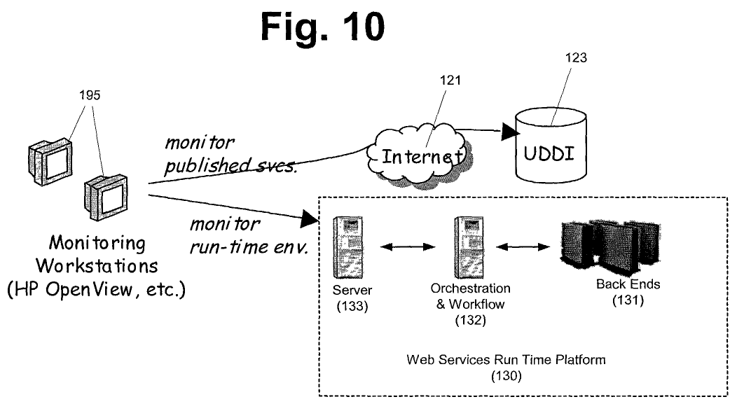

As shown in FIG. 10, monitoring workstations (195) using some or all of these tools, now known or later developed, for monitoring and/or modifying the operation of a Web service, monitoring the operation of the service itself on the Web services runtime platform (130). The monitoring workstations (195) may also monitor the “advertisement” of the service on a UDDI registry (123) and modify the information about the service in the registry (123) as needed.

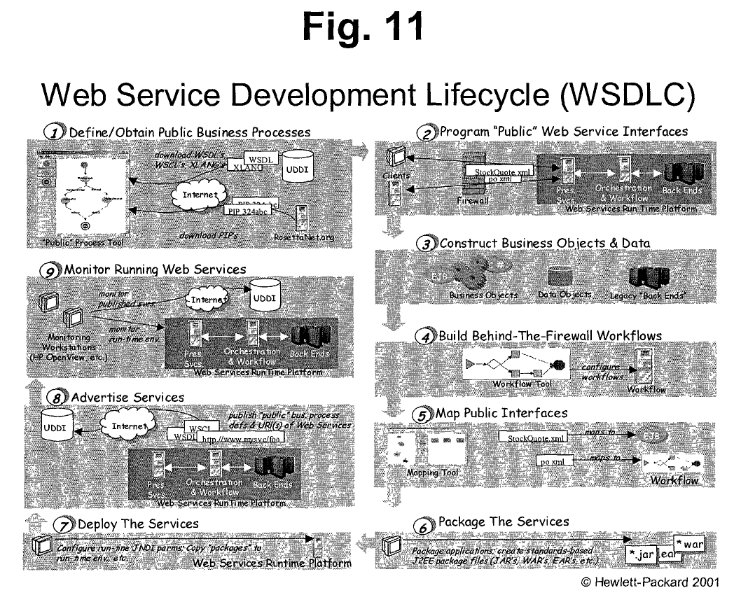

FIG. 11 is an aggregation of FIGS. 2 to 10. Like FIG. 1, FIG. 11 illustrates a preferred embodiment of the Web service development lifecycle model according to principles of the present invention.

FIG. 11 can be used to perform an educational and/or sales and marketing function. At present, the development of Web services is not always well understood by companies who wish to provide such services and who may have substantial existing software assets that could be parlayed into Web services.

Consequently, FIG. 11 can be presented to those interested in learning what is involved in developing a Web Service. FIG. 11 will provide a roadmap of all the necessary aspects of developing, deploying and operating a Web Service. Thus, the present invention encompasses methods of educating people about Web service development using, for example, the illustration in FIG. 11.

Also, companies that provide services, software, hardware, tools, equipment, etc. that can be used in completing any of the nine phases of Web service development outlined in FIG. 11 can use FIG. 11 or a similar visual, graphic or textual representation of the Web service development model of the present invention to market or sell their products or services. Thus, the present invention encompasses business methods that include presenting the Web service development model described herein for the purpose of marketing or selling products and services used to accomplish any aspect of any of the nine phases of Web service development shown in FIG. 1.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method of developing a Web service, said method comprising:
specifying a business protocol for communicating with said service;
programming a Web service interface;
constructing business objects and data;
building a service workflow;
mapping said interface to said business objects and workflow;
packaging said service;
deploying the service;
advertising the service; and
monitoring the service.

2. The method of claim 1, wherein said specifying a business protocol comprises adopting a Remote Procedure Call model for submitting requests to said service.

3. The method of claim 1, wherein said specifying a business protocol comprises adopting a document exchange model for submitting requests to said service.

4. The method of claim 1, wherein said programming a Web service interface comprises generating a Web Service Description Language (WSDL) file describing said service.

5. The method of claim 1, wherein said building a service workflow comprises designing said workflows to operate behind a firewall.

6. The method of claim 1, wherein said building a service workflow further comprises operating a workflow tool to build said service workflow.

7. The method of claim 1, wherein said mapping said interface further comprises mapping said interface with a mapping tool.

8. The method of claim 1, wherein said packaging said service further comprises combining components of said Web service into an archive file.

9. The method of claim 1, wherein said advertising the service further comprises listing said service in a Universal Description, Discovery and Integration (UDDI) repository.

10. A method of developing a Web service, said method comprising:
specifying a business protocol for communicating with said service;
programming a Web service interface;
constructing business objects and data;
building a service workflow;
mapping said interface to said business objects and workflow; and
packaging said service.

11. The method of claim 10, wherein said specifying a business protocol comprises adopting a Remote Procedure Call model for submitting requests to said service.

12. The method of claim 10, wherein said specifying a business protocol comprises adopting a document exchange model for submitting requests to said service.

13. The method of claim 10, wherein said programming a Web service interface comprises generating a Web Service Description Language (WSDL) file describing said service.

14. The method of claim 10, wherein said building a service workflow comprises designing said workflows to operate behind a firewall.

15. The method of claim 10, wherein said building a service workflow further comprises operating a workflow tool to build said service workflow.

16. The method of claim 10, wherein said mapping said interface further comprises mapping said interface with a mapping tool.

17. The method of claim 10, wherein said packaging said service further comprises combining components of said Web service into an archive file.

18. A method of marketing products or services used in developing a Web service, said method comprising presenting a Web service development model in conjunction with offering a product or service used in developing a Web Service.

19. The method of claim 19, wherein said Web service development model comprises:
specifying a business protocol for communicating with said service;
programming a Web service interface;
constructing business objects and data;
building a service workflow;
mapping said interface to said business objects and workflow;
packaging said service;
deploying the service;
advertising the service; and
monitoring the service.

20. The method of claim 18, further comprising presenting said model in a visual form.

21. The method of claim 18, further comprising presenting said model in a text form.

22. The method of claim 18, further comprising presenting said model in a graphic form.

23. The method of claim 18, further comprising presenting said model as a flowchart.

24. A system for developing a Web service, said system comprising:
means for specifying a business protocol for communicating with said service;
means for programming a Web service interface;
means for constructing business objects and data;
means for building a service workflow;
means for mapping said interface to said business objects and workflow;
means for packaging said service;
means for deploying the service;
means for advertising the service; and
means for monitoring the service.

25 The system of claim 24, wherein said means for specifying a business protocol comprise means for adopting a Remote Procedure Call model for submitting requests to said service.

26. The system of claim 24, wherein said means for specifying a business protocol comprise means for adopting a document exchange model for submitting requests to said service.

27. The system of claim 24, wherein said means for programming a Web service interface comprise means for generating a Web Service Description Language (WSDL) file describing said service.

28. The system of claim 24, wherein said means for building a service workflow comprise means for designing said workflows to operate behind a firewall.

29. The system of claim 24, wherein said means for building a service workflow comprise a workflow tool for building said service workflow.

30. The system of claim 24, wherein said means for mapping said interface comprise a mapping tool.

31. The system of claim 24, wherein said means for packaging said service further comprise means for combining components of said Web service into an archive file.

32. The system of claim 24, wherein said means for advertising the service further comprise means for listing said service in a Universal Description, Discovery and Integration (UDDI) repository.

33. A suite of software tools stored on media for storing computer-readable instructions, said suite comprising:
at least one tool for specifying a business protocol for communicating with said service;
at least one tool for programming a Web service interface;
at least one tool for constructing business objects and data;
at least one tool for building a service workflow;
at least one tool for mapping said interface to said business objects and workflow;
at least one tool for packaging said service;
at least one tool for deploying the service;
at least one tool for advertising the service; and
at least one tool for monitoring the service.
